(19) United States
(12) Patent Application Publication
(10) Pub. No.: US 2006/0053789 A1
(43) Pub. Date: Mar. 16, 2006

(54) Exhaust gas regulating element for supercharger systems of internal combustion engines

(76) Inventor: Guenther Vogt, Holzkirchen (DE)

Correspondence Address: KENYON & KENYON LLP, ONE BROADWAY, NEW YORK, NY, 10004, US

(21) Appl. No.: 11/201,005

(22) Filed: Aug. 9, 2005

(30) Foreign Application Priority Data
Aug. 13, 2004 (DE) 102004039294.3
Feb. 25, 2005 (DE) 102005009160.1

(51) Int. Cl. F02B 33/44

(52) U.S. Cl. 60/612

(57) ABSTRACT

A regulating element for a supercharger system, preferably including at least two exhaust gas turbochargers, in the exhaust system of an internal combustion engine. The regulating element is provided in a housing and is designed as a butterfly valve and is continuously pivotable around a pivot axis. The butterfly valve is provided with an edge area on its circumference, which cooperates with stop surfaces of the housing in a sealing area to form a flat seal. The butterfly valve is pivotably supported on at least one journal, the sealing area continuing at least via a partial circumference of a journal section encompassed by a housing sealing surface to form a tight seal.

### BACKGROUND INFORMATION

Supercharger systems are used in internal combustion engines to boost performance. Supercharger systems may include an individual exhaust gas turbocharger or two single-stage turbochargers connected in series and may be designed as a pressure wave supercharger, as an impulse supercharger, or the like. Via the supercharger system, the energy content of the exhaust gas of the internal combustion engine is used to increase pressure in the intake line of the internal combustion engine to boost the filling factor of the internal combustion engine cylinders, regardless of whether the engine has a spark ignition or an auto-ignition.

In the case of supercharger systems used in internal combustion engines, such as exhaust gas turbochargers, waste gates are known with which the exhaust gas mass flow acting upon the turbine part of the exhaust gas turbocharger is regulatable. The waste gates used for this purpose, which are operated via an actuator, are usually hinged on one side and, in their closed position, seal a channel running parallel to the turbine part of the exhaust gas turbocharger. In their open position, the waste gates unblock this parallel channel, through which exhaust gas in the turbine part of the exhaust gas turbocharger is able to flow directly into the exhaust pipe of the internal combustion engine. The waste gates presently used in exhaust gas turbochargers are usually hinged on one side and require considerable actuating forces, since the exhaust gas pressure places a considerable mechanical load on the waste gates that are hinged on one side, particularly when the internal combustion engine is operating at full load.

A throttle valve unit having an integrated throttle valve is described in German Patent Application No. DE 101 37 771. Throttle valves are customarily used in the intake lines of internal combustion engines and regulate the air mass flow that is supplied on the intake side of an internal combustion engine to fill the cylinders with the air needed for combustion. The throttle valve unit described in German Patent Application No. DE 101 37 771 is mounted in a throttle housing that includes two halves. A receptacle housing is accommodated on the throttle valve unit for an actuating drive operating the throttle valve unit. According to German Patent Application No. DE 101 37 771, the throttle valve unit is manufactured as a single piece in a single operation, using an injection molding process in which a frame structure is produced. The frame structure encompasses a valve surface on both sides of a valve shaft that has bearing elements. The throttle valve, which is designed as a butterfly valve, is mechanically reinforced by the frame structure injection-molded onto the valve surface.

### SUMMARY OF THE INVENTION

Unlike the waste gates currently used for supercharger systems, such as exhaust gas turbochargers, the regulating element according to the present invention may be used, in particular, to direct the exhaust gas mass flow alternately to the high-pressure turbine or the low-pressure turbine of a two-stage supercharger system. The regulating element according to the present invention is advantageously designed as a butterfly valve, which means low actuating forces develop, since the exhaust gas pressure does not subject the regulating element to a one-sided load.

The regulating element is also able to assume intermediate positions, enabling controlled throttling of the exhaust gas flow. The regulating element is parallel-connected to the high-pressure turbine part. The regulating element may be advantageously moved via an actuator, the actuator having an actuating member on which a transmission member is mounted. The latter is guided on a supporting element that is pivotable around a joint and applies a rotational movement to a rocking lever for operating the regulating element. This enables the regulating element to apply different actuating torques, depending on its actuating position.

The regulating element designed as a butterfly valve is made of a refractory metallic material. The regulating element is supported by at least one, preferably two, journals that are provided in the extension of the center axis at the end of the butterfly valve. The journal bearings may be designed either as friction bearings or as special needle bearings and made of a refractory metallic material. Due to the high temperatures that may occur in the exhaust system of an internal combustion engine, a higher-quality material is selected which meets, in particular, the thermal requirements and enables the regulating element to run smoothly even at high temperatures.

The regulating element and the housing encompassing it are preferably designed to have sufficient clearance to avoid elevated actuating forces even when heated. The stop surfaces interacting with the regulating element may be advantageously provided in the axial direction in the housing of the regulating element with regard to the exhaust gas mass flow.

The regulating element according to the present invention may be integrated as a single component into the exhaust manifold. Stop surfaces interacting with a sealing area of the regulating element may be integrated into the wall surfaces thereof.

Via the regulating element according to the present invention, an actuatable component that is pivotable around its pivot axis may be used to reverse the entire exhaust gas mass flow, while maintaining a good meterability even in the intermediate positions. The regulating element does not get stuck even if thermal expansion occurs, since the stop surfaces of the sealing surfaces are located in the direction of movement. A circumferential sealing edge ensures good sealing action, preventing the possibility of leakage flows thanks to the axial bearing support of the regulating element designed as a butterfly valve according to the present invention.

A particular advantage of the circumferential sealing area is that the latter also encompasses the journals. This improves the overall sealing action of the regulating element. This is advantageous, in particular, if two-stage supercharged engines behave in an unsteady manner, since the flow can be optimally supplied to the high-pressure turbine without leakage losses in the bypass line. In addition, this makes it possible to achieve higher pressure conditions in the high-pressure compressor.

### BRIEF DESCRIPTION OF THE DRAWINGS

FIG. 1 shows a cutaway representation of the regulating element according to the present invention, integrated into the exhaust gas manifold and movable around a pivot axis oriented perpendicular to the drawing plane.

FIG. 2 shows the view of a housing partially cut away having an integrated regulating element.

FIG. 3 shows a perspective top view of the housing partially cut away and the regulating element illustrated in FIG. 2.

FIG. 4 shows a perspective side view of the exhaust gas manifold area having the integrated regulating element.

### DETAILED DESCRIPTION

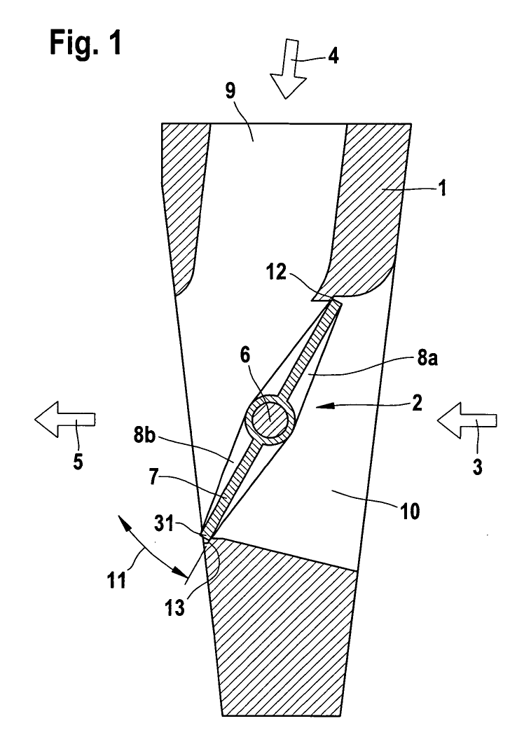

FIG. 1 shows a schematic view of an exhaust gas manifold provided in the exhaust system of an internal combustion engine. The exhaust gas manifold includes a housing 1 in which a regulating element 2 is mounted. Housing 1 is supplied with an exhaust gas flow 3 from the internal combustion engine and an exhaust gas flow 4 originating in a high-pressure turbine part of a first exhaust gas turbocharger, which is not illustrated in FIG. 1. An exhaust gas flow 5 is supplied from the housing illustrated in FIG. 1 to a low-pressure turbine part of a second exhaust gas turbocharger, which is not illustrated. However, the exhaust gas flow may also be supplied to a different location so that the exhaust gas flow does not act upon regulating element 2. In this case, regulating element 2 is inserted only between the internal combustion engine and the discharge point of the high-pressure turbine part into the exhaust gas line.

Regulating element 2 illustrated in FIG. 1 is pivotable around a pivot axis 6. FIG. 1 shows regulating element 2 in its closed position. When regulating element 2 is in its open position, i.e. if regulating element 2 is oriented horizontally with regard to the illustration according to FIG. 1, it is able to pivot in both directions, as indicated by double arrow 11. Regulating element 2 is designed as a butterfly valve 7 having a top side 8a and a bottom side 8b that have a hydrodynamic design. A circumferential edge area 31, which in the illustration according to FIG. 1 rests against a first stop surface 12 of housing 1 and against a second stop surface 13 of housing 1, is provided on regulating element 2. Exhaust gas flow 4, which originates in the high-pressure turbine part of the supercharger system, flows into housing 1 via an inflow opening 9; exhaust gas flow 3, which comes from the internal combustion engine, flows in via infeed opening 10 and passes regulating element 2 to a greater or lesser degree—depending on the pivot position around pivot axis 6.

Regulating element 2, which is able to pivot around pivot axis 6, is movable in the clockwise direction from the closed position shown in FIG. 1. In the illustration according to FIG. 1, edge area 31 of butterfly valve 7 rests against both first stop surface 12 of housing 1 and second stop surface 13 of housing 1. Regulating element 2 illustrated in FIG. 1 is designed as a butterfly valve that requires low actuating forces, since the exhaust gas does not subject it to a one-sided load, but instead acts upon both sides of pivot axis 6.

In the illustration shown in FIG. 1, edge area 31 of butterfly valve 7 is in contact with first stop surface 12 and second stop surface 13. This seals inflow opening 10 through which exhaust gas flow 3 is supplied to regulating element 2. In the position shown in FIG. 1, the butterfly valve of regulating element 2, which is positioned on its stop surfaces 12 and 13, unblocks a flow connection extending from the high-pressure turbine part of the two-stage supercharger system to low-pressure turbine part 5. This means that when regulating element 2 is in the position shown in FIG. 1, exhaust gas flow 3 of the internal combustion engine is conducted to a two-stage supercharger system via the series-connected turbine parts on the high-pressure and low-pressure sides.

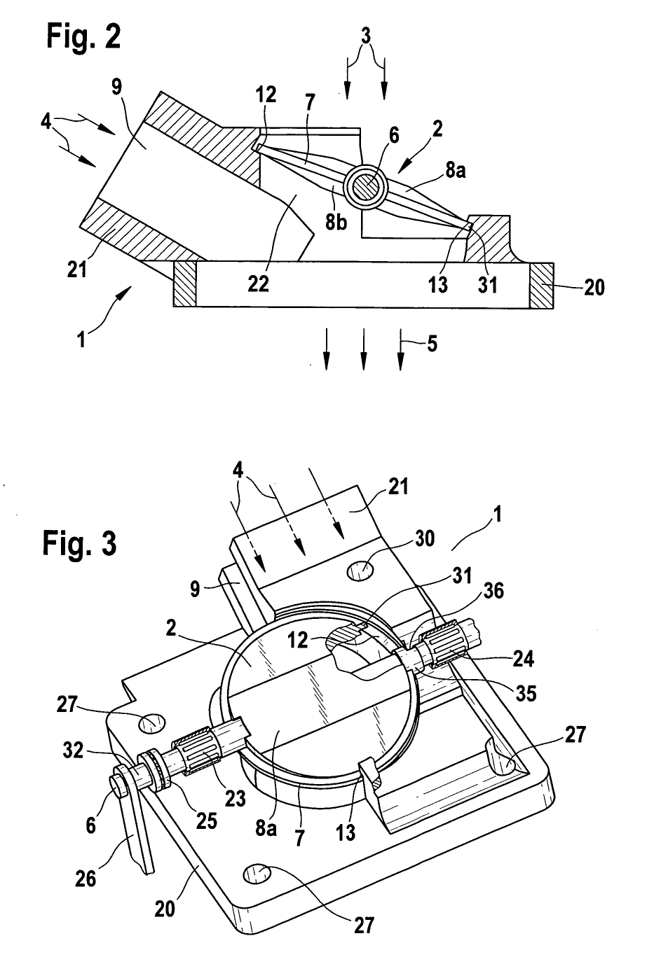

FIG. 2 shows a side view of a housing 1 which accommodates regulating element 2 according to the present invention.

Exhaust gas flow 4 from the high-pressure turbine part of the two-stage supercharger system flows to housing 1 via connecting piece 21. A housing base 20 that represents a fastening flange is provided on housing 1. Reference numeral 22 designates the inside of housing 1, within which regulating element 2 is pivotable around pivot axis 6. As shown in FIG. 2, butterfly valve 7 is provided with an edge area 31 on its circumference which cooperates with stop surfaces 12, 13 of the housing in a sealing area to form a flat seal. For this purpose, edge area 31 of butterfly valve 7 is provided with a first sealing surface in a partial area of top side 8a of butterfly valve 7 for contact with stop surface 13 of housing 1, and with a second sealing surface in a partial area of bottom side 8b of butterfly valve 7 for contact with stop surface 12. With regard to exhaust gas flow 3, which is supplied to housing 1 from the internal combustion engine, first stop surface 12 and second stop surface 13 are advantageously oriented in the axial direction in the housing. As illustrated in FIG. 2, the first sealing surface and the second sealing surface are provided alternately on the top and bottom sides of butterfly valve 7. According to the illustration in FIG. 2, the opening in housing 1 via which exhaust gas flow 3 is supplied from the internal combustion engine is closed by valve 7 of regulating element 2. The axial support of regulating element 2 prevents leakage flows. FIG. 3 shows the axial support of regulating element 2.

As shown in FIG. 2, first stop surface 12 of housing 1 engages with the circumferential edge area of valve 7; this also applies to second stop surface 13 of housing 1, thus achieving a good sealing action and allowing the exhaust gas flow of the internal combustion engine to be conducted almost entirely via the two-stage supercharger system.

Reference numeral 4 designates the exhaust gas flow supplied to housing 1 from the high-pressure turbine part of the two-stage supercharger system; reference numeral 5 indicates the exhaust gas flow that is supplied from housing 1 to a low-pressure turbine part of the two-stage supercharger system. Regulating element 2 is made entirely of a refractory material, such as metal. Between edge area 31 of butterfly valve 7 of regulating element 2 and the housing walls encompassing edge area 31 is an axial clearance in the area of first stop surface 12 and second stop surface 13 to ensure that regulating element 2 is able to be operated smoothly by its drive even when heated, and elevated actuating forces are not required due to sticking in the heated state.

The illustration shown in FIG. 3 is a cutaway perspective top view of the housing illustrated as a cutaway view in FIG. 2.

Regulating element 2 has the ribbed areas shown in FIG. 2 on its front and back sides. Journals 32, which form the bearing points of regulating element 2 in housing 1, are visible on regulating element 2. The journals coincide with pivot axis 6 of valve surface 7 of regulating element 2. As shown in FIG. 3, journals 32 may also run, for example, on needle bearings 23, 24 in housing 1. In addition to using needle bearings 23, 24 made of a refractory material, journals 32 of regulating element 2 may also be mounted on friction bearings within housing 1. The illustration according to FIG. 3 also shows axial bearing 25 provided on journal 32. Journal 32 is actuatable by an actuating member 26 via which regulating element 2 is pivotable around pivot axis 6 in its housing 1. FIG. 3 shows a cutaway view of valve 7 to reveal first stop surface 12 provided on the housing side, on which rests edge area 31 of valve 7 in the position shown in FIG. 3. As further illustrated in FIGS. 1 through 4, the sealing area continues via a partial circumference of a journal section 35 of the two journals 32 that is encompassed by a housing sealing surface 36 to form a tight seal. In particular, the first sealing surface is continued via a partial circumference of journal section 35 on top side 8a of butterfly valve 7, and the second sealing surface is continued at least via a partial circumference of journal section 35 on bottom side 8b of butterfly valve 7.

Housing 1 has multiple bores 27 which may be used to connect housing 1, into which regulating element 2 according to the present invention is integrated, to a conduit system provided in the exhaust system of an internal combustion engine. The portion of housing 1 designed as a base 20 is connected using a connecting flange to the inlet of the low-pressure turbine of the multi-stage supercharger system and facing the latter, while an exhaust pipe running from the high-pressure part of the two-stage supercharger system to housing 1 is connectable to connecting piece 21.

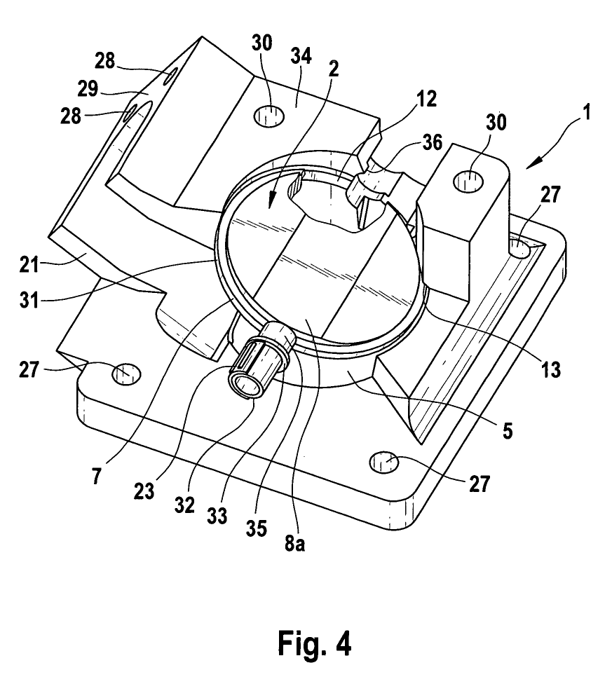

FIG. 4 shows a perspective top view of the housing according to the illustrations in FIGS. 2 and 3, having an integrated regulating element.

In the interest of clarity, the illustration in FIG. 4 shows only one of journals 32 of regulating element 2, which coincides with its pivot axis 6. In the illustration according to FIG. 4, a first needle bearing 23 that rests against a ring 33 of journal 32 is provided on journal 32 of regulating element 2. The position of ring 33 defines the position of first needle bearing 23 on journal 32.

Housing 1 illustrated in the perspective top view according to FIG. 4 includes bores 27 mentioned in connection with FIG. 3 for fastening housing 1 to a line section facing the low-pressure turbine part within the exhaust system of the internal combustion engine. In addition, an end face 29 that is provided with multiple flange bores 28 is provided on connecting piece 21 on housing 1. Via flange bores 28, housing 1 is connectable to a conduit part of the exhaust system, via which exhaust gas flow 4, which originates in the high-pressure turbine part of the two-stage supercharger system, may be supplied to housing 1. In addition, the housing shown in FIG. 4 includes a further end face 34 in which flange bores 30 are also provided. The conduit section via which exhaust gas flow 3 from the internal combustion engine is supplied to housing 1 is attached to additional end face 34, this conduit section sealing inflow opening 10 illustrated in FIG. 1 when regulating element 2 is in its closed position, i.e., when it rests against first stop surface 12 or second stop surface 13. In the pivot position of regulating element 2 shown in FIG. 4, the flow cross section of connecting piece 21, via which exhaust gas flow 4 is conducted from the high-pressure turbine part, is short-circuited by the discharge cross section via which exhaust gas flow 5 is conducted to the low-pressure turbine part of the two-stage supercharger system.

Regulating element 2 designed as a butterfly valve and illustrated in FIGS. 1 through 4 makes it possible to use a single component to reverse the entire exhaust gas flow 3. Regulating element 2 is continuously pivotable around its pivot axis 6, making it possible to effectively meter exhaust gas flow 3 even in the intermediate positions, i.e., in positions in which the circumferential sealing area provided on valve 7 does not rest against first stop surface 12 or second stop surface 13 of housing 1 and thus allows exhaust gas to flow via the space formed thereby.

In addition, regulating element 2 according to the present invention and able to be integrated into the exhaust gas manifold area requires only low actuating forces due to its design as a butterfly valve, since the exhaust gas pressure does not act upon only one side of valve surface 7 of regulating element 2, but is applied uniformly with regard to pivot axis 6. Because first stop surface 12 and second stop surface 13 in housing 1 are designed so that they are located behind circumferential edge area 31 of valve surface 7 with regard to the opening movement of regulating element 2, regulating element 2 does not get stuck. The design of circumferential edge area 31 in the circumferential direction achieves a good sealing action. The good sealing action is improved by designing regulating element 2 as a butterfly valve and thereby implementing an axial support of pivot axis 6, which prevents exhaust gas leakage flows from occurring. FIGS. 1 through 4 show regulating element 2 in its closed position. When the regulating element is in this position, exhaust gas flow 3, which is supplied to the housing from the internal combustion engine, flows over the high-pressure turbine part and the low-pressure turbine part of the two-stage supercharger system.

### LIST OF REFERENCE NUMERALS

1 Housing
2 Regulating element
3 Exhaust gas flow from the internal combustion engine
4 Exhaust gas flow from the high-pressure turbine part
5 Exhaust gas flow to the low-pressure turbine part
6 Pivot axis
7 Butterfly valve
8a/b Top/bottom side of the valve surface
9 Inflow opening for exhaust gas flow 4
10 Inflow opening for exhaust gas flow 3
11 Directions of rotation
12 First stop surface on the housing side
13 Second stop surface on the housing side
20 Base
21 Connecting piece
22 Inner wall
23 First needle bearing
24 Second needle bearing
25 Axial bearing
26 Actuating member
27 Bore
28 Flange bore for line to HP turbine part
29 End face
30 Flange bore for exhaust pipe
31 Edge area
32 Journal
33 Ring
34 Additional end face
35 Journal section
36 Housing sealing surface

What is claimed is:

1. A regulating element for a supercharger system in an exhaust system of an internal combustion engine, the regulating element being situated in a housing to which at least one of (a) an exhaust gas mass flow of the internal combustion engine and (b) an exhaust gas mass flow of the internal combustion engine and an exhaust gas mass flow of an exhaust gas turbocharger situated upstream from the regulating element is supplied, the regulating element comprising:
a butterfly valve which is continuously pivotable around a pivot axis and cooperates with stop surfaces in the housing to form a flat seal.

2. The regulating element according to claim 1, wherein the supercharger system is a multi-stage supercharger system having series-connected exhaust gas turbochargers.

3. The regulating element according to claim 1, wherein the butterfly valve has an edge area on its circumference that cooperates with the stop surfaces in a sealing area to form a flat seal.

4. The regulating element according to claim 3, wherein the butterfly valve is pivotably supported on at least one journal, and the sealing area continues at least over a partial circumference of a journal section of the at least one journal encompassed by a housing sealing surface to form a tight seal.

5. The regulating element according to claim 1, wherein the regulating element is parallel-connected to a high-pressure turbine part of the supercharger system.

6. The regulating element according to claim 1, wherein the pivot axis of the regulating element is supported by one of (a) friction bearings and (b) needle bearings in the housing.

7. The regulating element according to claim 6, wherein the needle bearings are made of a refractory material.

8. The regulating element according to claim 1, wherein the stop surfaces are oriented in an axial direction with regard to the exhaust gas mass flow.

9. The regulating element according to claim 1, wherein an edge area of the butterfly valve has a first sealing surface in a partial area of a top side of the butterfly valve and a second sealing surface in a partial area of a bottom side of the butterfly valve.

10. The regulating element according to claim 9, wherein the first sealing surface continues at least over a partial circumference of a journal section on the top side of the butterfly valve, and the second sealing surface continues at least over a partial circumference of a journal section on the bottom side of the butterfly valve.
